(19) United States
(12) Patent Application Publication
(10) Pub. No.: US 2010/0189947 A1
(43) Pub. Date: Jul. 29, 2010

(54) POLYMERIC COMPOSITE ADHESIVE TAPE

(75) Inventors: Jerry SERRA, Chelmsford, MA (US); Samuel J. Chen, Lexington, MA (US); Allison Luss-Lusis, Cambridge, MA (US); Albert Marquis, Lowell, MA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/721,175

(22) Filed: Mar. 10, 2010

Related U.S. Application Data
(62) Division of application No. 11/553,568, filed on Oct. 27, 2006.

(51) Int. Cl. B32B 33/00; B32B 15/20

(52) U.S. Cl. 428/40.1; 428/457

(57) ABSTRACT

An adhesive tape comprising a layer of metallized polymeric material having a first side and a second side, and a layer of adhesive compound applied to the first side of the layer of metallized polymeric film is provided. An adhesive tape meeting Underwriter Laboratories criteria for use with both rigid and flexible air ducts and air connectors, comprising a layer of metallized polymeric material having a first side and a second side, and a layer of adhesive compound applied to the first side of the layer of metallized polymeric material is also provided. Additionally provided is a pressure-sensitive adhesive tape comprising a film backing having a predetermined tensile strength and a predetermined heat stability, a compounded adhesive layer coated on a side of the backing, and a release liner material laminated to an exposed side of the compounded adhesive layer.

### CROSS REFERENCE TO RELATED APPLICATION

This application is a divisional application of U.S. patent application Ser. No. 11/553,568, filed on Oct. 27, 2006.

### BACKGROUND

1. Field of the Invention

Embodiments of the present invention generally relate to an adhesive tape for application in heating, ventilation, and air conditioning systems. In particular, embodiments of the present invention relate to a polymeric composite adhesive tape comprising a metallized polymeric material backing and a composite adhesive compound that can withstand high and low temperatures and has increased longevity.

2. Description of the Related Art

Foil tapes, e.g., pressure-sensitive or heat-bonded aluminum tapes are known in the art for use with both rigid and flexible air ducts and connectors associated with heating, ventilation, and air conditioning (HVAC) systems. Examples of such foil tapes include, but are not limited to, POLYKEN 339 (available from Covalence Adhesives, LLC), NASHUA 324A (available from Covalence Adhesives, LLC), FASSON 0810 (available from Avery Dennison Corp.), IDEAL 587 (available from Ideal Tape Co., Inc.), VENTURE 1581A (available from Venture Tape Corp.), and SHURTAPE AF-100 (available from Shurtape Technologies, Inc.). Biaxially-oriented polypropylene (BOPP) tape, both metallized and non-metallized, and cloth-backed tapes, such as duct tape, also are known to be used with flexible air ducts and air connectors.

Underwriter Laboratories, Inc. (UL), a well known source for providing product compliance requirements, has imposed very severe standards and specifications for use of such tapes with rigid air ducts or air connectors (UL181A) and for use with flexible air ducts or air connectors (UL181 B). Consequently, there is a need for an improved adhesive tape for use with both rigid and flexible air ducts and connectors that addresses the criteria of both UL181A and UL181 B, and has improved longevity.

### SUMMARY

Embodiments of the present invention include an adhesive tape comprising a layer of metallized polymeric material having a first side and a second side, and a layer of adhesive compound applied to the first side of the layer of metallized polymeric film.

Another embodiment of the present invention includes an adhesive tape comprising a layer of metallized polymeric material having a first side and a second side, a layer of adhesive compound applied to the first side of the layer of metallized polymeric film, and a layer of release liner material applied to an exposed side of the layer of adhesive compound.

In yet another embodiment of the present invention, there is provided an adhesive tape meeting Underwriter Laboratories criteria for use with both rigid and flexible air ducts and air connectors comprises a layer of metallized polymeric material having a first side and a second side, and a layer of adhesive compound applied to the first side of the layer of metallized polymeric material.

Another embodiment of the present invention includes an adhesive tape comprising a layer of metallized laminate having a first side and a second side, and a layer of adhesive compound applied to the first side of the layer of metallized laminate. The metallized laminate may comprise a layer of polymeric film laminated to a layer of metal foil.

Another embodiment of the present invention includes an adhesive tape comprising a layer of metallized paper material having a first side and a second side, and a layer of adhesive compound applied to the first side of the layer of metallized paper material.

In yet another embodiment of the present invention, there is provided a pressure-sensitive adhesive tape comprising a film backing having a predetermined tensile strength and a predetermined heat stability, a compounded adhesive layer coated on a side of the backing, and a release liner material laminated to an exposed side of the compounded adhesive layer.

### BRIEF DESCRIPTION OF THE DRAWING

So the manner in which the above recited features of the present invention can be understood in detail, a more particular description of embodiments of the present invention, briefly summarized above, may be had by reference to embodiments, one of which is illustrated in the appended drawing. It is to be noted, however, the appended drawing illustrates only a typical embodiment of embodiments encompassed within the scope of the present invention, and, therefore, is not to be considered limiting, for the present invention may admit to other equally effective embodiments.

FIG. 1 is an adhesive tape, in accordance with an embodiment of the present invention.

FIG. 2 is a graph showing the results of the heat aging for the tested adhesive tape.

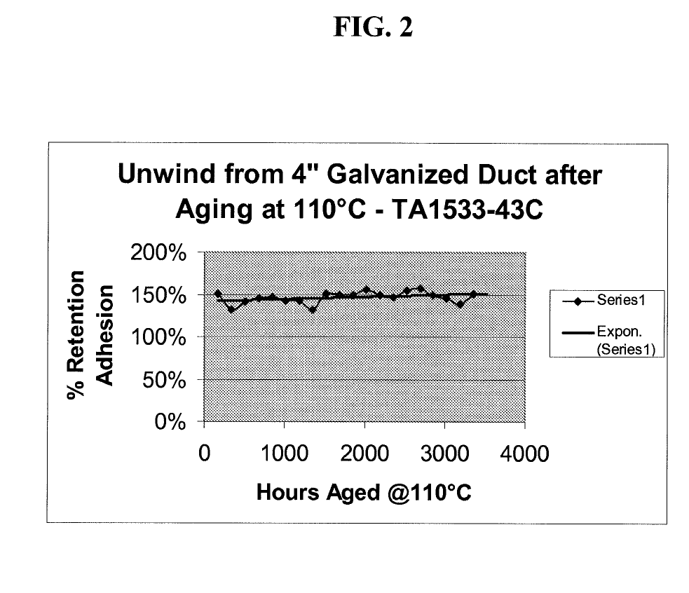

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figure.

### DETAILED DESCRIPTION

UL is an organization dedicated to developing standards of safety for multiple products that are accepted by multiple industries. Millions of products and their components are tested to UL's rigorous safety standards with the result that consumers live in a safer environment than they would have otherwise. For the purposes of this invention, the essential UL specifications and requirements are provided below:

### UL181A Specifications

The requirements covered in UL cover adhesive tapes for use with rigid air ducts or air connectors complying with the Standard for Factory-Made Air Ducts and Air Connectors, UL181. This standard includes pressure-sensitive adhesive tapes. Embodiments of the present invention include adhesive tapes that address the following tests in the UL181A specification, namely, the tensile strength test, the peel adhesion at 180 degree angle, and the shear adhesion test.

### Tensile Strength Test

The average tensile strength in both the machine and cross-machine directions of each roll of aluminum tape shall be not less than 25 pounds per inch (4.37 N/mm) of width, with no individual specimen having a value of less than 21 pounds per inch (3.67 Newtons per millimeter or N/mm) of width, determined in accordance with the Standard Test Method for Tensile Strength and Elongation of Pressure-Sensitive Tapes, ASTM D3759-2005. All cross-direction specimens are to be cut from special 6 inch (142.4 mm) wide rolls of tape. Three specimens from each of three separate rolls of tape shall be tested in both the machine and cross-machine directions. The average tensile strength of each set of three specimens shall not be less than 25 pounds per inch (4.37 N/mm) of width, when specimens are prepared with a laboratory specimen cutter.

### Peel Adhesion at 180 Degree Angle

The average peel adhesion strength of each roll of aluminum tape shall be not less than 3.75 pounds per inch (0.66 N/mm) of width of tape, with no individual specimens having a value of less than 3.20 pounds per inch (0.56 N/mm) of width. The peel adhesion strength of aluminum tape is to be determined in accordance with the Standard Test Methods for Peel Adhesion of Pressure-Sensitive Tape at 180 Degrees Angle, ASTM D3330-83, except as modified hereinafter. Specimens are to be cut in 1 inch (25.4 mm) wide by 12-inch (305 mm) long strips. The tape is to be applied (as specified in ASTM 3330-83) to the specified stainless steel panel with a roller weighing 10 pounds-mass (4.53 kg). The roller is to pass over each specimen five times in each direction. The test load is applied 15 minutes after completion of the rolling.

### Shear Adhesion Test Conditions

The shear adhesion strength of tape shall be such that the tape is able to maintain the test loads specified in Table 1 for the indicated test durations without evidence of separation or slippage in excess 1/32 inch (0.79 mm). The shear adhesion strength of aluminum tape is to be determined in accordance with Procedure C of the Standard Test Method for Holding Power of Pressure-Sensitive Tapes, ASTM D3654-82, except as modified below. After conditioning, a 2-inch (50 mm) length of specimen is to contact the panel. The tape is to be applied to the panel with a roller weighing 10 pounds-mass (4.53 kg). The roller is to pass over each specimen five times in each direction. Using a cutting razor blade or jig, the rolled portion of the specimen is to be trimmed to 1 by 1 inch square on the panel, such that the remaining test specimen measures 1 by 5 inches. The tape is allowed to dwell on the panel for the time specified in Table 1. After dwelling, the clamp is to be placed on the free end of the specimen. The clamp is to extend completely across the width of the specimen and is to be aligned to uniformly distribute the load. The test load specified in Table 1 is then to be applied to the clamp gently so as not to cause any shear impact force on the specimen. The load is to be applied for the test duration time specified in Table 1. The test panel is to be positioned at 2 degrees from the vertical so that the test substrate forms a 178 degree angle with the extended tape specimen. Individual specimens of tape are to be tested in accordance with the conditions as shown in Table 1:

TABLE 1

| | Application | | | | |
|---|---|---|---|---|---|
| Test No. | Conditions | Dwell Time | Test Load | Test | Duration |
| 2. | 40° F. (4.4° C.) | 15 minutes | 40° F. | 5 lbs. | 6 hours |
| | dry substrate | (22.2 N) | | | |
| 3 | 73.4° F. (23° C.) | 15 minutes | 73.4° F. | 5 lbs | 6 hours |
| | 50% RH | | | | |
| 4. | 73.4° F. (23° C.) | 24 hours | 73.4° F. | 10 lbs | 120 hours |
| | 50% RH | | | | |
| 5. | 73.4° F. (23° C.) | 15 minutes | 150° F. (65.6° C.) | 5 lbs | 6 hours |
| | 50% RH. | | | | |

The shear adhesion strength of the tape (in each of the above tests) shall be such that the tape is able to maintain the test loads specified in the tests for the indicated test durations without evidence of separation or slippage in excess of 1/32 inch (0.79 mm).

The aforementioned tests (tensile strength, peel adhesion, and shear adhesion) constitute the essential criteria that are critical to achieve in order to provide an adhesive tape meeting the UL181A specifications for use with air ducts and connectors. However, for the sake of accuracy, it is to be noted that they are not the only tests which must be passed to satisfy the UL181A specifications. One such test is peel adhesion at a 20 degree angle. This criterion will be met if the adhesive tape passes the critical tests described above.

Other UL181A criteria, specifically surface burning characteristics, mold growth and humidity tests, temperature/pressure cycling tests, burning test and manufacturing and production tests, as detailed in UL181A, are not as difficult to meet and for purposes of a clear understanding of the nature and objects of this invention need not be described.

### UL181B Specifications

The requirements covered in UL181B cover adhesive tapes for use with flexible air ducts or air connectors complying with the Standard for Factory-Made Air Ducts and Air Connectors, UL181. These adhesive tapes consist of pressure-sensitive systems. Embodiments of the present invention include adhesive tapes that address the following tests in the UL181B specification, namely, the tensile strength test, the peel adhesion at 180 degree angle, and the shear adhesion test.

An adhesive tape that addresses the criteria of the UL181A specification will also address the criteria defined in the UL181B specification. However, the pertinent criteria of the UL181B are provided herewith for clarification:

### Tensile Strength Test

The average tensile strength in the machine direction of each roll of tape shall be not less than 17 pounds per inch (2.97 N/mm) of width, with no individual specimen having a value of less than 15 pounds per inch (2.62 N/mm) of width, when tested in accordance with the Standard Test Method for Tensile Strength and Elongation of Pressure-Sensitive Tapes, ASTM D3759-2005. The average tensile strength in the cross machine direction of each roll of tape shall not be less than 8 pounds per inch (1.40 N/mm) of width, with no individual specimen having a value of less than 7.5 pounds per inch (1.31 N/mm) of width, when tested in accordance with ASTM D3759-1988. Three specimens from each of three separate rolls of tape shall be prepared with a laboratory specimen cutter for both machine and cross machine directions.

### Peel Adhesion Test at 180 Degree Angle

The average peel adhesion strength of the pressure-sensitive tape shall not be less than 30 ounces per inch (0.33 N/mm) of width of tape with no individual specimen having a value less than 25 ounces per inch (0.27 N/mm) applied to the specified stainless steel panel, and tested in accordance with the Standard Test Methods for Peel Adhesion of Pressure-Sensitive Tape at 180 Degree Angle, ASTM D3330-1990, Method A—Single Coated Tapes. The average peel adhesion strength of pressure-sensitive tape shall not be less than 25 ounces per inch (0.27 N/mm) of width of tape with no individual specimen having a value of less than 20 ounces per inch (0.22 N/mm) applied to the tape's own backing and tested in according with ASTM D3330-1990, Method A—Single Coated Tapes.

Three specimens from each of three separate rolls of tape are to be tested. Specimens are to be cut in 1 inch (25.4 mm) wide by 12 inch (305 mm) long strips. The tape is to be applied to a stainless steel substrate as specified in ASTM D3330-1990. The tape is to be applied to its own backing such that no bending is possible during the test. The test load is to be applied immediately after completion of the rolling.

### Shear Adhesion Test

The shear adhesion strength of tape shall be such that the tape is able to maintain the test loads specified in Table 2 for twenty-four hours without evidence of separation or slippage in excess of ⅛ inch (3.18 mm).

TABLE 2

| Dwell Conditions | Dwell Time | Test Conditions | Test Load | | Test Duration |
|---|---|---|---|---|---|
| N/A | N/A | 73.4° F. (23° C.) | 2 | lbs (8.9N) | 24 hours |
| | | 50 percent RH | | | |
| N/A | N/A | 150° F. (65.5° C.) | 100 | grams (1.0 N) | 24 hours |
| 150° F. (65.6° C.) | 60 days | 73.4° F. (23° C.) | 100 | grams (1.0 N) | 24 hours |
| | | 50 percent RH | | | |

The aforementioned tests (tensile strength, peel adhesion at 180 degree angle, and shear adhesion) constitute the essential criteria that are critical to achieve in order to provide an adhesive tape meeting the UL181B specifications for use with flexible air ducts and air connectors. However, for the sake of accuracy, it is to be noted that they are not the only tests which must be passed to satisfy the UL181B specifications. Such tests include surface burning characteristics, mold growth and humidity, and temperature, which are not as difficult to meet and for purposes of a clear understanding of the nature and objects of this invention need not be described.

Thus, embodiments of the present invention include adhesive tapes that address both the UL181A and UL181B requirements and specifications, and also adhesive tapes with improved stability such that the adhesive tapes maintain their required adhesive characteristics in climates with elevated temperatures for an extended lifespan. Additionally, embodiments of the present invention provide adhesive tapes having improved adhesion and tack in cold climates. Further, embodiments of the present invention include adhesive tapes that address the UL181B requirements while maintaining their required adhesive characteristics in climates with elevated temperatures for an extended lifespan.

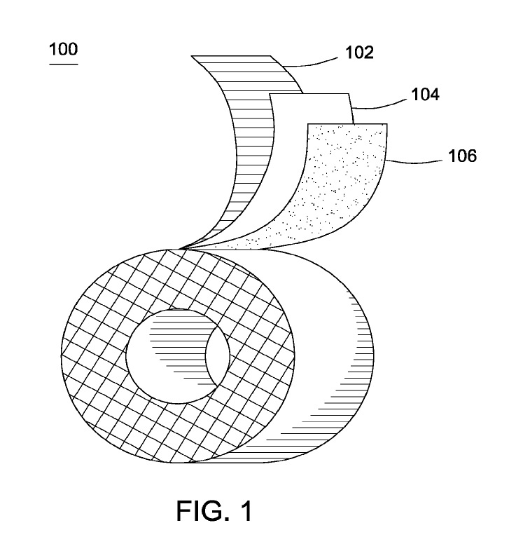

FIG. 1 presents an adhesive tape 100 in accordance with an embodiment of the present invention. The adhesive tape 100 comprises a layer of metallized polymeric film 102 as a backing and a layer of adhesive compound 104. The adhesive tape 100 may further comprise a release liner material 106 applied to the layer of adhesive compound 104. By omitting the release liner material 106, the tape may be manufactured and packaged as a self-wound roll. The release liner material 106 is not a necessary component for the adhesive tape 100 to meet the UL181A or UL 181B criteria. Embodiments of the present invention include both hand-tearable adhesive tapes, wherein a hand-tearable tape is a tape that may be torn or cut by hand without the use of a cutting or tearing tool, and non-hand tearable adhesive tapes, wherein a non-hand tearable tape is a tape that may not be torn or cut by hand without the use of a cutting or tearing tool.

The layer of metallized polymeric film 102 may be made of metallized polyester, metallized polypropylene, metallized polyethylene, metallized polycarbonate, metallized polyethylene naphthalate, metallized fluoropolymer, and the like, or any combination thereof. The polymeric film may be coated with a thin layer of metal, such as, for example, aluminum or an aluminum alloy, to create the metallized polymeric film, according to an embodiment of the present invention. According to another embodiment, the metallized polymeric film 102 may comprise a laminate of a foil material, such as, for example, aluminum or an aluminum alloy, and a polymeric film, such as polyester, polypropylene, such as BOPP, or polyethylene, and the like, or any combination thereof In one embodiment, the metallized polymeric material is a laminate of metallized polyester and aluminum foil. According to an aspect of this embodiment, the aluminum foil has a thickness of about 0.2 thousandths of an inch (“mils”) to about 1.44 mils.

The layer of metallized polymeric film may be of a predetermined thickness ranging from about 0.9 mils to about 10 mils, depending on the intended end application for the adhesive tape. In another embodiment, an adhesive tape comprises a layer of metallic polymeric film and a layer of adhesive compound, wherein the layer of metallic polymeric film has a thickness between about 0.92 mils to about 1.44 mils.

In another embodiment of the present invention, an adhesive tape comprises a metallized paper material and a layer of adhesive compound. The metallized paper material may be a super-calendered kraft paper coated with a thin layer of aluminum, such as GEPALUX (available from Schoeller & Hoesch GmbH & Co., KG).

In yet another embodiment of the present invention, an adhesive tape comprises a metallized scrim backing and a layer of adhesive compound. The metallized scrim backing may comprise a woven or non-woven scrim material, including, but not limited to cotton, polyester, nylon, one or more polymeric materials, and the like.

The layer of adhesive compound 104 may be any pressure-sensitive adhesive, such as, for example, silicone, rubber, polyurethane-based, water-based acrylic, and solvent-based adhesives, and both heat-bonded and cold-bonded adhesives. The adhesive compound 104 may also be an aggressive compounded adhesive, such as, for example, those described in U.S. Pat. Nos. 4,880,880, 4,997,709, and 5,405,703, each of which is incorporated herein by reference. The layer of adhesive compound 104 may be applied to either side of the layer of metallized polymeric film 102. In one embodiment of the present invention, the layer of adhesive compound 104 is applied to the metal coated side of the metallized polymeric film 102.

In yet another embodiment of the present invention, the layer of adhesive compound includes a tackifying resin to improve application of the adhesive tape in cold temperatures. In one embodiment, the layer of adhesive compound includes 15 percent by weight of a terpene phenolic resin, such as SP-553 available from Schenectady International. In another embodiment of the present invention, the layer of adhesive compound includes about 5 percent to about 30 percent by weight of a rosin ester resin, such as, for example FORAL 105 (available from Hercules Incorporated), PICCOFYN A115 (available from Hercules Incorporated), SYLVARES TP300 (available from Arizona Chemical Co.), and TAMANOL 803L (available from Arakawa Chemical Co.).

The release liner material 106 may be applied to the exposed side of the layer of adhesive compound 104 using a coating process, such as, extrusion coating, a lamination process, such as, extrusion lamination, or other application processes. The release liner material 106 may be a silicone liner material, or non-silicone release liner material, such as polyvinyl octadecylcarbamate. Examples of non-silicone release liner materials include, but are not limited to, ESCOAT P-20 (available from Polyad Co.), RA-95H (available from Mayzo, Inc.), and RA-150W (available from Mayzo, Inc.). An embodiment of the present invention includes an adhesive tape with a polyvinyl stearylcarbamate release liner material, such as RA-95E (available from Polyad Co.) In another embodiment of the present invention, an adhesive tape includes a vinyl acrylic emulsion release liner material, such as DEGREE 650V (available from Solv, Inc.). In yet another embodiment, an adhesive tape including a fluorochemical emulsion release liner material with an acrylic backbone, such as RA-120W (available from Mayzo, Inc.), is provided. In yet another embodiment, a release coating material may be applied to a side of the metallized polymeric film opposite the layer of adhesive compound, such as, for example, an acrylic emulsion release coating.

Another embodiment of the present invention includes a pressure-sensitive adhesive tape comprising a film backing with a compounded adhesive layer coated on one side of the film backing. An aspect of this embodiment further includes a release liner material laminated to the compounded adhesive layer opposite the film backing. The film backing may have predetermined tensile strength and heat stability such that the pressure-sensitive tape addresses the UL181A and UL181B criteria and substantially maintains its adhesive characteristics in operating temperatures above about 350 degrees Fahrenheit and below about minus 35 degrees Fahrenheit. Examples of film backings include a laminate of paper and oriented polypropylene, a laminate of a layer of foil and a scrim, such as, for example, a woven or non-woven scrim, a laminate of a polymer and a layer of foil, such as, for example, FPT 3575 and FPT 3592 (available from Pin Quest, Inc), and laminates of a polymer and foil available from Covalence Coated Products, Inc., and a metallized polymer, including, but not limited to, metallized BOPP, such as Grade TU35 (available from Inteplast Group, Ltd.) and Grade BNUV (available from Vifran, Inc.), and metallized polyester, such as the metallized polyester films available from CPFilms (a division of Solutia, Inc.), FILMtech, Inc, Rol-Vac, LP, and Dunmore Corp.

The novel combination of a metallized polymeric film or other film backing with an adhesive compound provides an adhesive tape that addresses the stringent UL181A and UL181B criteria but also creates an adhesive tape that has improved stability in hot climates and improved adhesion and tack in cold climates. Embodiments of the present invention include adhesive tapes that have an average tensile strength of at least about 25 lb/in and an individual tensile strength of at least about 21 lb/in in both the machine and cross-machine directions. Embodiments of the present invention have an average peel adhesion of about 60 oz/in and an individual peel adhesion of about 51 oz/in at 180 degrees. Embodiments of the present invention maintain stability at temperatures ranging between about 350 degrees Fahrenheit to about minus 35 degrees Fahrenheit, in accordance with the requirements of UL181A and UL181B. Further, the use of the metallized polymeric film 102 with an adhesive compound 104 provides a cost competitive adhesive tape 100 in comparison with foil tapes.

An embodiment of the present invention includes an adhesive tape that addresses the Underwriter Laboratories criteria for use with flexible air ducts and air connectors. The adhesive tape of this embodiment comprises a layer of metallized polyester and a layer of adhesive compound. The adhesive tape has an improved longevity and retains the required adhesive characteristics for up to about thirty years in temperatures at about 230 degrees Fahrenheit. The adhesive tape may further comprise a release liner material applied to the layer of adhesive compound opposite the layer of metallized polyester. Another embodiment comprises an adhesive tape of a layer of non-metallized polyester material and a layer of an adhesive compound.

The following example shows by way of illustration, and not by way of limitation, the practice of embodiments of this invention.

### Example 1

In this example, adhesive tapes were made using a metallized polyester film backing (“met PET”) and an adhesive compound (TA1533-1). Another adhesive tape was made using a laminate of aluminum foil and polyester film (“foil/PET”) as the backing material. The thickness of the metallized PET varied from 0.9 mils to 2 mils. Another adhesive tape was made using a laminate of aluminum foil and polyester film (“foil/PET”) as the backing material, with a thickness of 1.3 mils. Some of the example adhesive tapes further include a tackifying resin, either FORAL 105 (available from Hercules Inc.) PICCOFYN A115 (available from Hercules Incorporated), SP-553 (available from Schenectady International), SYLVARES TP300 (available from Arizona Chemical Co.), or TAMANOL 803L (available from Arakawa Chemical Co.), added to the adhesive compound in an amount of about 5 percent to about 30 percent by weight.

These example adhesive tapes were subjected to the tensile strength tests, the peel adhesion at 180 degree tests, and the cold and hot shear adhesion tests as described in the UL181A and UL181B specifications. Common aluminum foil tapes, POLYKEN 339 and FASSON 0810, were subjected to the same tests as controls.

Tables 3A-3C sets forth the results for these tests:

TABLE 3A

| | | | Polyken | Fasson | | | |
|---|---|---|---|---|---|---|---|
| TA# | | | 339 | 0810 | 1533-48D | 1533-48A | 1533-48B |
| Coating Method | | | | | pilot | pilot | pilot |
| Adhesive | | | | | 1533-1 | 1533-48B | 1533-48B |
| Adhesive Lot | | | | | | 0086 | 0086 |
| Additive | | | | | None | None | None |
| Additive Amt | | | | | 0 | 0 | 0 |
| Backing | | | Foil | Foil | met PET | met PET | BOPP |
| | UL181A | UL181B | | | 181B | 181B | 181B |
| Tensile | 25/25 | 17/8 | | | 26/34 | 26/34 | 21/28 |
| strength (MD/CD), lb/in | | | | | | | |
| Total Thickness, mil | | | 4.55 | 4.7 | 2.5 | 2.5 | 2.9 |
| Backing Thickness, mil | | | 2.45 | 2.12 | 0.92 | 0.92 | 1.4 |
| Adhesive Thickness, mil | | | 2.1 | 2.6 | 1.5 | 1.5 | 1.5 |
| 180° ADST, ozf/in | 60 | 30 | 78 | 59.6 | 39.5 | 58.7 | 44.5 |
| 180°ADBK, oz/in | | 25 | | | 35.7 | 51 | 26.5 |
| Probe Tack | | | 420 | 408 | 477 | 657 | 572 |
| 30° F. AD to ductboard, | | | 25 | 20 | | | |
| Initial | | | | | | | |
| 1 hr dwell | | | 39 | 32 | | | |
| 30° F. Cold Stick**, Initial | | | 5 | 5 | | | |
| 1 hr Dwell | | | 5 | 5 | | | |
| RT Shear Test | 1/32″ | | < 1/32″ | < 1/64″ | | | |
| (Slippage) | | | | | | | |
| 1″ × 1″ × 101b for 5 days | | | | | | | |
| 150° F. Shear Test | 1/32″ | | 1/64″ | < 1/64″ | | | |
| 1″ × 1″ × 5 lb for 6 hrs | | | | | | | |
| (slippage) | | | | | | | |
| 40° F. Shear Test | | | | | | | |
| 1″ × 1″ × 5 lb for 6 hrs | | | | | | | |
| (slippage) | | | | | | | |
| Shear, 24 hr (<⅛″ slip) | | <⅛″ | | | | | |
| 1′ × 1″ × 2 lb × RT | | | | | no slip | | no slip |
| 1″ × 1″ × 100 × 150° F. | | | | | no slip | | no slip |

Adhesive:
1533-1: Solvent based acrylic,
1533-48B: Acrylic emulsion,
A: Rosin ester resin.
B: Terpene phenolic resin;
*Tore fiberglass ductboard

TABLE 3B

| TA# | 1450-35 | 1531-27A | 1533-84D | 1531-27W | 1531-27P | 1531-46A |
|---|---|---|---|---|---|---|
| Coating Method | Drawdown | | Pilot | Drawdown | | |
| Adhesive | 1533-1 | 1533-1 | 1533-1 | 1533-1 | 1533-1 | 1533-1 |
| Adhesive Lot | 182A | 8068A | 65-30 | 8068W | 8068W | 184 |
| Additive | None | None | None | A | B | B |
| Additive Amt | 0 | 0 | 0 | 10% | 5% | 12% |
| Backing | met PET | PET | met PET | PET | PET | PET |
| | 181A/B | 181A/B | 181A/B | 181A/B | 181A/B | 181A/B |
| Tensile | 47/59 | 47/59 | 42/47 | | | |
| strength(MD/CD), lb/in | | | | | | |
| Total Thickness, mil | 2.7 | 4.2 | 3.6 | 3.9 | 4.1 | 4.15 |
| Backing Thickness, mil | 2 | 2 | 1.44 | 2 | 2 | 2 |
| Adhesive Thickness, mil | 4.7 | 2.2 | 2.1 | 1.9 | 2.1 | 2.2 |
| 180° ADST, ozf/in | 70.3 | 75.3 | 61 | 70 | 75.2 | 88.7 |
| 180° ADBK, oz/in | | | 41.6 | | | |
| Probe Tack | NA | 798 | 690 | 551 | 619 | 902 |
| 30° F. AD to ductboard, | | | 29 | | | |
| Initial | | | | | | |
| 1 hr dwell | | | 32 | | | |
| 30° F. Cold Stick**, | | | 6* | | | |
| 1 hr Dwell | | | 8* | | | |
| RT Shear Test | | | | | | |
| (Slippage) | | | | | | |
| 1″ × 1″ × 101b for 5 days | | | | | | |
| 150° F. Shear Test | 1/32″ | 1/64- 1/32″ | | 1/64″ | 1/32″ | 1/64″ |
| 1″ × 1″ × 5 lb for 6 hrs | | | | | | |
| (slippage) | | | | | | |
| 40° F. Shear Test | | | no slip | | | |
| 1″ × 1″ × 5 lb for 6 hrs | | | | | | |
| (slippage) | | | | | | |
| Shear, 24 hr (<⅛″ slip) | | | | | | |
| 1′ × 1″ × 2 lb × RT | | | | | | |
| 1″ × 1″ × 100 × 150° F. | | | | | | |

Adhesive:
1533-1: Solvent based acrylic,
1533-48B: Acrylic emulsion,
A: Rosin ester resin.
B: Terpene phenolic resin;
*Tore fiberglass ductboard

TABLE 3C

| TA# | 1531-46B | 1531-46C | 1531-46D | 1533-84B | 1533-84C |
|---|---|---|---|---|---|
| Coating Method | Pilot | Pilot | Pilot | Pilot | Pilot |
| Adhesive | 1533-1 | 1533-1 | 1533-1 | 1533-1 | 1533-1 |
| Adhesive Lot | 184 | 184 | 184 | 65-30 | 65-30 |
| Additive | B | B | B | B | B |
| Additive Amt | 13% | 14% | 15% | 10% | 20% |
| Backing | PET | PET | PET | met PET | met PET |
| | 181A/B | 181A/B | 181A/B | 181A/B | 181A/B |
| Tensile | | | | 42/47 | 42/47 |
| strength(MD/CD), lb/in | | | | | |
| Total Thickness, mil | 4.15 | 4.2 | 4.3 | 3.6 | 3.6 |
| Backing Thickness, mil | 2 | 2 | 2 | 1.44 | 1.44 |
| Adhesive Thickness, mil | 2.2 | 2.2 | 2.3 | 2.1 | 2.1 |
| 180°ADST, ozf/in | 89.7 | 91.6 | 92.4 | 75.8 | 96.7 |
| 180°ADBK, oz/in | | | | | |
| Probe Tack | 1017 | 1043 | 970 | 776 | 729 |
| 30° F. AD to ductboard, | | | | 23 | 10 |
| Initial | | | | | |
| 1 hr dwell | | | | 24 | 22 |
| 30° F. Cold Stick**, Initial | | | | 6* | 5 |
| 1 hr Dwell | | | | 7 | 5 |
| RT Shear Test | | | | 1/64- 1/32″ | 1/64- 1/32″ |
| (Slippage) | | | | | |
| 1″ × 1″ × 10 lb for 5 days | | | | | |
| 150° F. Shear Test | 1/64″ | 1/64″ | 1/64″ | 1/64″ | 1/64″ |
| 1″ × 1″ × 5 lb for 6 hrs | | | | | |
| (slippage) | | | | | |
| 40° F. Shear Test | | | | no slip | |
| 1″ × 1″ × 5 lb for 6 hrs | | | | | |
| (slippage) | | | | | |
| Shear, 24 hr (<⅛″ slip) | | | | | |
| 1′ × 1″ × 2 lb × RT | | | | | |
| 1″ × 1″ × 100 g × 150° F. | | | | | |

Adhesive:
1533-1: Solvent based acrylic,
1533-48B: Acrylic emulsion,
A: Rosin ester resin.
B: Terpene phenolic resin;
*Tore fiberglass ductboard

As seen, the tested examples easily met and exceeded the tensile strength tests, the peel adhesion at 180 degree tests, and the shear adhesion tests outlined in UL181A and the peel adhesion test outlined in UL181B. Additionally, the example adhesive tapes had improved tack over the control tapes.

The tested examples also were subjected to the 30 degree Fahrenheit Performance Tests (adhesion to UL181A-rated fiberglass ductboard and cold-stick test) as described in the US181A specification. To prepare the test panels, the ductboard backing was removed from the fiberglass and applied to a stainless steel panel with carpet tape. The ductboard backing then was wiped clean with a gauze pad. Test panels and test samples were conditioned at 30 degrees Fahrenheit. One-inch wide tape samples were applied to the test panels with a no. 10 roller rolled once in 1 direction at 12 inches per minute. The adhesion of the tape samples to the test panel was tested with continuous rate of extension device when the sample was initially applied to the test panel, and after 1 hour of dwelling on the test panel.

For the 30 degree Fahrenheit cold-stick test, the tape samples were conditioned at 30 degrees Fahrenheit. The tape samples then were applied to ductboard backing with a squeegee. The Fasson 0810 acted as the control tape, with an adhesion rating of “5.” The tape samples then were samples removed from the ductboard by hand and rated against the control for adhesion to the ductboard at 30 degrees Fahrenheit. This test was performed when the tape samples were first applied to the ductboard, and after 1 hour of dwelling on the ductboard. As shown in Tables 3A-3C, the tested tape samples demonstrated superior performance over the requirements provided in the UL181A specification for both 30 degree Fahrenheit Performance Tests.

### Example 2

In this example, an adhesive tape addressing the stringent criteria of UL181B for flexible air ducts and air connectors was made using a non-metallized or plain polyester film backing with an adhesive compound. The thickness of the plain polyester film backing was 0.92 mils. The adhesive tape was subjected to an accelerated aging process to demonstrate stability performance at elevated temperatures of about 230 degrees Fahrenheit for a period of about 21 weeks. The accelerated aging process was used to evaluate the stability of the adhesive tape over an accelerated lifetime of about thirty years. To prepare the adhesive tape samples, a 4-inch diameter galvanized duct was cut into multiple test panels of approximately 6-inch lengths. The test panels were wiped clean with a gauze pad moistened with isopropanol. Five one-inch wide strips of tape were applied around the circumference of each test panel with finger pressure. The adhesion to the test panels was tested using a continuous rate of extension device at a pull rate of 12 inches per minute using an unwind jig. Approximately two inches of tape were unwound from a test panel during a test. The force was measured in inch-ounces (“ozf/in”). The adhesion of the tape samples to each test panel was tested prior to the heat aging process. The prepared tape samples and test panels then were placed in an oven at 230 degrees Fahrenheit. The tape samples and test panels were removed from the oven every seven days and conditioned to room temperature, approximately 73 degrees Fahrenheit at 50% relative humidity. The adhesion of the tape samples to the test panels was tested, and the tape samples and test panels then were returned to the oven for further aging. This testing was performed for a minimum of 21 weeks.

As shown in Graph 1, a trend line was used to estimate the amount of time in hours required for the adhesive tape to retain 50% of the original adhesion value. From previous research, the applicant has learned that for an adhesive tape to last 30 summers, the tape must retain at least 50% of the original peel-adhesion at 230 degrees Fahrenheit (110 degrees Celsius) for 3450 hours, or about 21 weeks. Graph 1 demonstrates the tested tape sample will last at least 30 summers given the peel adhesion of the tape sample is stable and not declining at about 21 weeks.

While the foregoing is directed to embodiments of the present invention, other and further embodiments of the invention may be devised without departing from the basic scope thereof, and the scope thereof is determined by the claims that follow.

1.-51. (canceled)

52. A self-wound adhesive tape, comprising:
a metallized polymeric backing having a first side and a second side;
an adhesive layer in contact with the first side of the metallized polymeric backing; and
a release layer in contact with the second side of the metallized polymeric backing, wherein
the self-wound adhesive tape has a first thickness of about 2 mil to about 4 mil,
the metallized polymeric backing has a second thickness of about 0.9 mil to about 2.0 mil,
the self-wound adhesive tape has an average tensile strength of at least about 25 lb/inch in both a machine direction and a cross-machine direction,
the self-wound adhesive tape has an average peel adhesion of at least about 60 oz/in at 180 degrees, and
the self-wound adhesive tape maintains stability at an operating temperature between about minus 35 degrees to about 350 degrees Fahrenheit.

53. The self-wound adhesive tape of claim 52, wherein the self-wound adhesive tape may be torn or cut by hand without the use of a cutting or tearing tool.

54. The self-wound adhesive tape of claim 53, wherein the self-wound adhesive tape has an individual tensile strength of at least about 21 lb/inch in both a machine direction and a cross-machine direction.

55. The self-wound adhesive tape of claim 53, wherein the metallized polymeric backing is metallized polyester.

56. The self-wound adhesive tape of claim 53, wherein the metallized polymeric backing is metallized polypropylene.

57. The self-wound adhesive tape of claim 52, wherein the self-wound adhesive tape has an individual peel adhesion of at least about 51 oz/in at 180 degrees.

58. The self-wound adhesive tape of claim 57, wherein the first side of the metallized backing is a metal-coated side such that the adhesive layer is in contact with the metal-coated side of the metallized polymeric backing.

59. The self-wound adhesive tape of claim 52, wherein the metallized polymeric backing comprises an aluminum alloy on the first side.

60. The self-wound adhesive tape of claim 59, wherein the adhesive layer in contact with the aluminum alloy includes about 15 percent by weight of a terpene phenolic resin.

61. The self-wound adhesive tape of claim 59, wherein the adhesive layer in contact with the aluminum alloy includes about about 5 percent to about 30 percent by weight of a rosin ester resin.

62. A self-wound pressure-sensitive tape, comprising:
a metallized polymeric backing having a first side and a second side;
a pressure-sensitive adhesive layer in contact with the first side of the metallized polymeric backing; and
a release layer,
wherein the metallized polymeric backing, the pressure-sensitive adhesive layer and the release layer are configured such that the self-wound pressure-sensitive tape maintains stability at an operating temperature from about minus 35 degrees to about 350 degrees Fahrenheit.

63. The self-wound pressure-sensitive tape of claim 62, wherein the metallized polymeric backing, the pressure sensitive adhesive layer, and the release layer are configured such that the self-wound pressure-sensitive tape has average tensile strength of at least about 25 lb/inch in both a machine direction and a cross-machine direction.

64. The self-wound pressure-sensitive tape of claim 63, wherein the metallized polymeric backing, the pressure sensitive adhesive layer, and the release layer are configured such that the self-wound pressure-sensitive tape has tensile strength is an individual tensile strength of at least about 21 lb/inch in both a machine direction and a cross-machine direction.

65. The self-wound pressure-sensitive tape of claim 64, wherein the metallized polymeric backing, the pressure sensitive adhesive layer, and the release layer are configured such that the self-wound pressure-sensitive tape has an average peel adhesion of at least about 60 oz/inch at 180 degrees.

66. The self-wound pressure-sensitive tape of claim 65, wherein the metallized polymeric backing, the pressure-sensitive adhesive layer, and the release layer are configured such that the self-wound pressure-sensitive tape has an individual peel adhesion of at least about 51 oz/in at 180 degrees.

67. The self-wound pressure-sensitive tape of claim 66, wherein the metallized polymeric backing has a first thickness of from about 0.9 mils to about 2 mils and the self-wound pressure-sensitive tape has a second thickness of about 2 mil to about 4 mil.

68. The self-wound pressure-sensitive tape of claim 67, wherein the metallized polymeric backing comprises polyester and aluminum.

69. The self-wound pressure-sensitive tape of claim 68, wherein the self-wound adhesive tape may be torn or cut by hand without the use of a cutting or tearing tool.

70. The self-wound pressure-sensitive tape of claim 69, wherein the release layer comprises an acrylic emulsion

71. The self-wound pressure-sensitive tape of claim 62, further comprising a metal foil.

72. The self-wound pressure-sensitive tape of claim 71, wherein the metal foil is laminated to the second side of metallized polymeric backing.

73. The self-wound pressure-sensitive tape of claim 72, wherein the metal foil is laminated to the second side of metallized polymeric backing.

74. The self wound pressure sensitive tape of claim 73, wherein the release layer is coated on a side of the metal foil opposite of the metallized polymeric backing and the metallized polymeric backing, the metal foil, the pressure-sensitive adhesive layer, and the release liner are configured such that the self-wound pressure-sensitive tape is self wound.

75. The self wound pressure sensitive tape of claim 62, wherein the release layer is not removable.
